(19) United States
(12) Patent Application Publication
(10) Pub. No.: US 2026/0134128 A1
(43) Pub. Date: May 14, 2026

(54) ARTIFICIAL INTELLIGENCE-BASED ACCESS-RELATED SYSTEMS IN MULTI-CLOUD ENVIRONMENTS

(71) Applicant: Dell Products L.P., Round Rock, TX (US)

(72) Inventors: Karan Kapoor, Bangalore (IN); Guru Shyam Chatty, Bangalore (IN); Bijan Kumar Mohanty, Austin, TX (US); Hung T. Dinh, Austin, TX (US)

(21) Appl. No.: 18/944,523

(22) Filed: Nov. 12, 2024

(51) Int. Cl. G06F 21/62; G06N 20/00

(52) U.S. Cl. CPC G06F 21/6218; G06N 20/00

(57) ABSTRACT

Methods, apparatus, and processor-readable storage media for implementing artificial intelligence-based access-related systems in multi-cloud environments are provided herein. An example computer-implemented method includes processing, into one or more data structures, usage data of software by at least one user device, wherein the processing is carried out within a multi-cloud environment; generating one or more software usage compliance determinations by processing at least a portion of the data structure(s) against one or more software access-related parameters associated with the at least one user device and the multi-cloud environment; determining one or more software access-related actions to be carried out in connection with the at least one user device by processing at least a portion of the software usage compliance determination(s) using one or more artificial intelligence techniques; and automatically performing, within the multi-cloud environment, at least one of the one or more software access-related actions with respect to the software.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

License enforcement has traditionally been used in connection with software in efforts to protect intellectual property from misuse. However, conventional software management approaches often create security risks and require resource-intensive reactive remediation efforts.

### SUMMARY

Illustrative embodiments of the disclosure provide artificial intelligence-based access-related systems in multi-cloud environments.

An exemplary computer-implemented method includes processing, into one or more data structures, usage data of software by at least one user device, wherein the processing is carried out within a multi-cloud environment, and generating one or more software usage compliance determinations by processing at least a portion of the one or more data structures against one or more software access-related parameters associated with the at least one user device and the multi-cloud environment. The method also includes determining one or more software access-related actions to be carried out in connection with the at least one user device by processing at least a portion of the one or more software usage compliance determinations using one or more artificial intelligence techniques. Further, the method includes automatically performing, within the multi-cloud environment, at least one of the one or more software access-related actions with respect to the software.

Illustrative embodiments can provide significant advantages relative to conventional software management approaches utilizing subscription-based arrangements. For example, problems associated with security risks and the need for resource-intensive reactive remediation efforts are overcome in one or more embodiments through automatically determining and executing one or more software access-related actions by processing software usage compliance data using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing an artificial intelligence-based access-related system in a multi-cloud environment in an illustrative embodiment.

FIG. 2 shows example system architecture in an illustrative embodiment.

FIG. 3 shows example architecture of a reinforcement learning (RL) agent in an illustrative embodiment.

FIG. 4 shows example pseudocode for installing libraries and defining parameters in connection with implementing at least a portion of an RL agent in an illustrative embodiment.

FIG. 5 shows example pseudocode for implementing at least a portion of an RL agent with a proximal policy optimization (PPO) model in an illustrative embodiment.

FIG. 6 is a flow diagram of a process for implementing an artificial intelligence-based access-related system in a multi-cloud environment in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

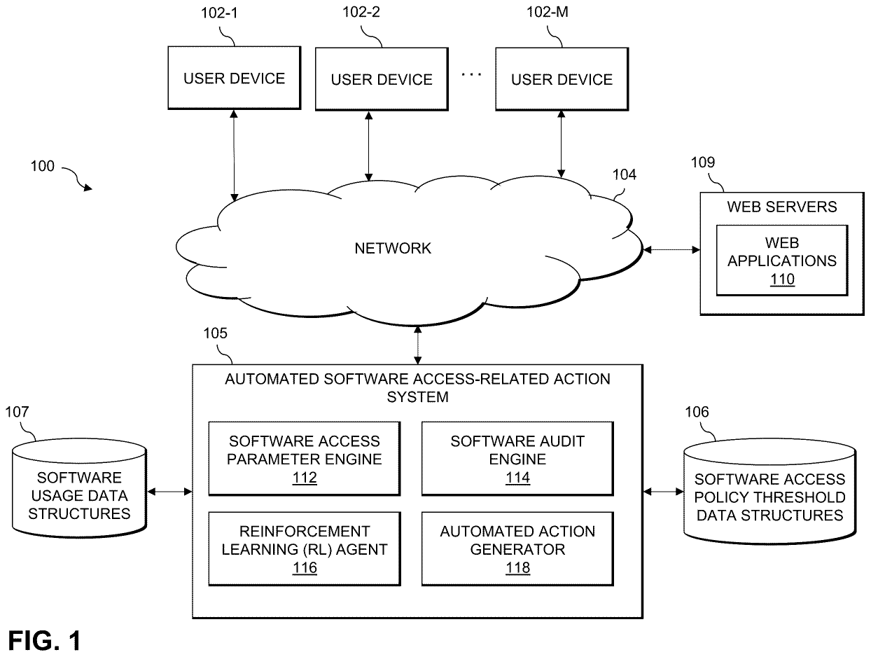

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated software access-related action system 105 and one or more web applications 110 running on one or more web servers 109.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated software access-related action system 105 can have one or more software access policy threshold data structures 106 configured to store data pertaining to status information, activity name and/or identification information, threshold values, etc. Also, as depicted in FIG. 1, the automated software access-related action system 105 can have one or more software usage data structures 107 configured to store data pertaining to software-related activity and/or actions, entitlements, historical compliance, consumption information, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The software access policy threshold data structures 106 and/or software usage data structures 107 in the present embodiment are implemented using one or more storage systems associated with the automated software access-related action system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated software access-related action system 105 are one or more input-output devices, which illustratively comprise keyboards, displays or other types of input-output devices in any combination. Such input-output devices can be used, for example, to support one or more user interfaces to the automated software access-related action system 105, as well as to support communication between the automated software access-related action system 105 and other related systems and devices not explicitly shown.

Additionally, the automated software access-related action system 105 in the FIG. 1 embodiment is assumed to be implemented using at least one processing device. Each such processing device generally comprises at least one processor and an associated memory, and implements one or more functional modules for controlling certain features of the automated software access-related action system 105.

More particularly, the automated software access-related action system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated software access-related action system 105 to communicate over the network 104 with the user devices 102, and illustratively comprises one or more conventional transceivers.

The automated software access-related action system 105 further comprises software access parameter engine 112, software audit engine 114, reinforcement learning (RL) agent 116, and automated action generator 118.

As detailed herein, and in connection with one or more embodiments, the software access parameter engine 112 can define one or more tiers of one or more different software access and/or usage compliance thresholds, and the software audit engine 114 can implement and/or execute core logic for measuring software consumption against one or more user activity parameters. Additionally, in such an embodiment, the automated action generator 118 can determine which action or actions are to be taken, e.g., after an audit is carried out by the software audit engine 114, and the RL agent 116 can implement at least one artificial intelligence-based model to learn policies for managing compliance and usage control with respect to the given software and the corresponding multi-cloud environment.

It is to be appreciated that this particular arrangement of elements 112, 114, 116 and 118 illustrated in the automated software access-related action system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for implementing an artificial intelligence-based access-related system in a multi-cloud environment involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated software access-related action system 105, software access policy threshold data structures 106, software usage data structures 107, and web servers 109 can be on and/or part of the same processing platform.

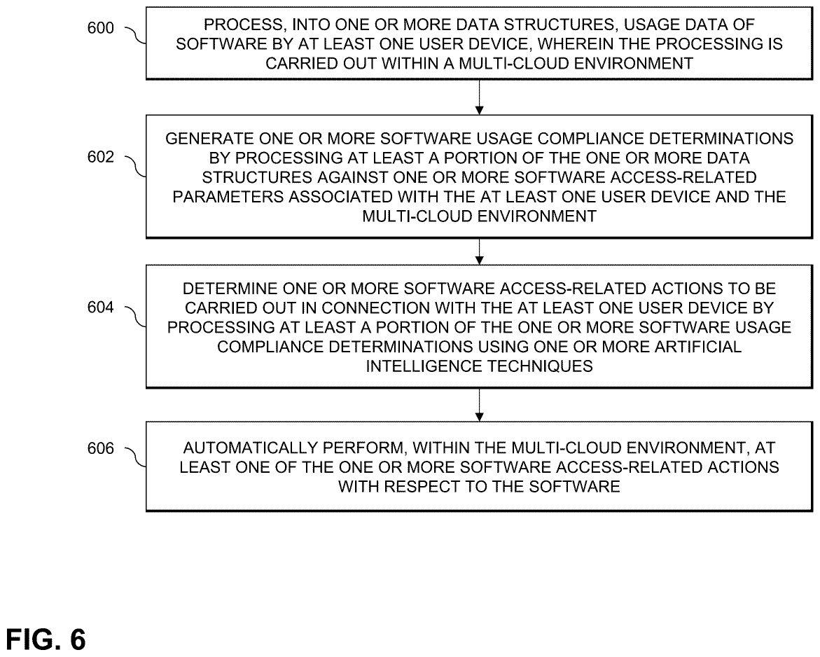

An exemplary process utilizing elements 112, 114, 116 and 118 of an example automated software access-related action system 105 in computer network 100 will be described in more detail with reference to the flow diagram of FIG. 6.

Accordingly, at least one embodiment includes generating and/or implementing an artificial intelligence-based multi-cloud subscription protection framework. As further detailed herein, such an embodiment includes dynamically reacting to software utilization thresholds in multi-cloud environments by automatically adjusting system actions using at least one artificial intelligence model based at least in part on the use of the software and measuring such use against at least one designated policy.

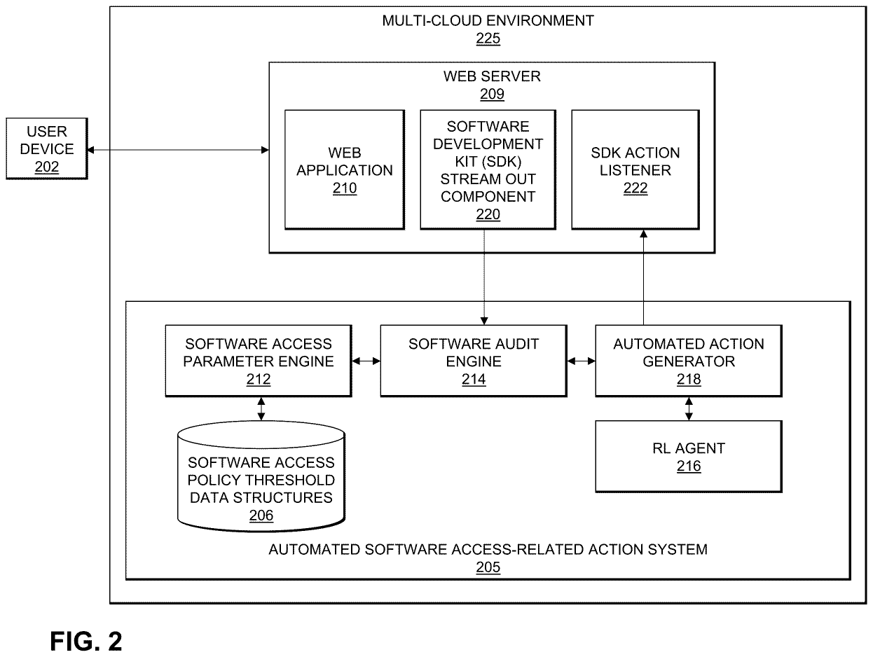

FIG. 2 shows example system architecture in an illustrative embodiment. By way of illustration, FIG. 2 depicts an automated software access-related action system 205 and a web server 209 operating within a multi-cloud environment 225. More particularly, in the example embodiment depicted in FIG. 2, the automated software access-related action system 205 includes software access parameter engine 212, software audit engine 214, RL agent 216, automated action generator 218, and software access policy threshold data structures 206.

The software access parameter engine 212 defines, in connection with data from at least a portion of the software access policy threshold data structures 206, one or more tiers of one or more different compliance thresholds. The software audit engine 214 implements and/or executes core logic for measuring software consumption associated with web application 210 against one or more user activity parameters (e.g., commerce parameters). Additionally, the automated action generator 218, operating in conjunction with the RL agent 216, determines one or more actions to carry out in connection with an audit carried out by the software audit engine 214. Further, the RL agent 216 implements at least one artificial intelligence-based model to learn policies (e.g., one or more optimal policies) for managing compliance and usage control with respect to at least a portion of the software associated with web application 210, and the corresponding multi-cloud environment 225.

As also depicted in FIG. 2, software development kit (SDK) components can be integrated into web server 209 and used in conjunction with the given software of the web application 210 to interact with the automated software access-related action system 205. For example, an SDK stream out component 220 processes and/or meters consumption, by user device 202, of one or more software features and/or components, and streams the data (e.g., in a real time asynchronous manner) to the software audit engine 214. An audit is then triggered and executed by the software audit engine 214, wherein at least a portion of the consumption data is aggregated and measured against one or more aggregated entitlements associated with the particular user device 202 in connection with use of the given software. In one or more embodiments, an entitlement can refer to a record that establishes a right-to-use a given resource in a certain quantity and for a certain term.

In connection with measuring one or more different types of compliance functions, the software audit engine 214 calculates the degree of compliance for the user device 202 against one or more thresholds in the designated policy. In one or more embodiments, compliance functions can include different types of measures that can be collectively used to assess a user's license consumption status. Example compliance functions can include capacity compliance functions, paid-term compliance functions, trial-term compliance functions, max-installs compliance functions, uncounted feature compliance functions, etc.

Additionally, the RL agent 216 processes at least a portion of the compliance function outputs, and determines the affinity of each software feature towards, for example, one or more capital expenditure (CapEx) actions (e.g., restrictive actions) and/or one or more operating expense (OpEx) actions (e.g., revenue generating actions) based at least in part on reinforcement learning of historic compliance and policy threshold data in connection with user rewards. With affinity and degree determinations made (as noted above), the automated action generator 218 can map the action(s) to be taken (e.g., one or more actions corresponding to the given threshold, such as, e.g., generating automated messages, disabling one or more features, triggering one or more deprovisioning lifecycles, etc.) and return an identification of the action(s) to an SDK action listener 222. The SDK action listener 222 can then implement the identified action(s), thereby enabling a dynamic and calculated response to the user device's 202 usage of the software.

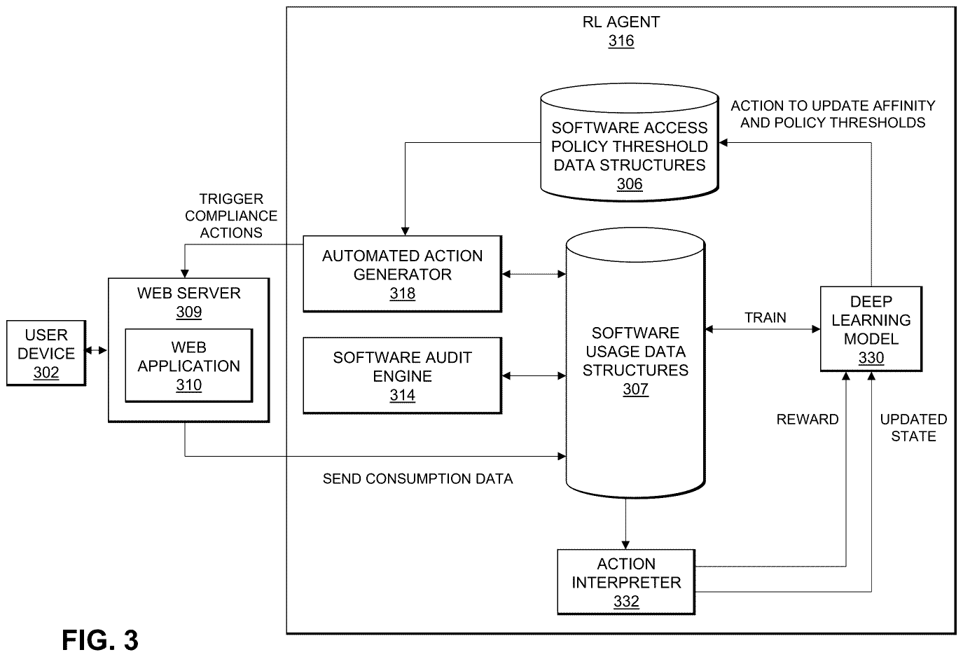

FIG. 3 shows example architecture of an RL agent in an illustrative embodiment. By way of illustration, FIG. 3 depicts RL agent 316 which implements a deep learning model 330 trained with RL in connection with one or more suggested affinity actions and/or other data stored in at least a portion of software usage data structures 307. In one or more embodiments, deep learning model 330 can include at least one RL model, which learns over time with trial and error, using a reward and penalty model. Such an embodiment can also include using one or more deep neural network-based algorithms (e.g., PPO, deep Q-network (DQN), async advantage actor critic (A3C), etc.) to implement the RL learning approach.

The RL agent 316 can guide an automated action generator towards one or more appropriate actions by dynamically toggling the affinity towards restrictive or revenue generating types of actions. Accordingly, RL techniques can be leveraged to enhance licensing and subscription costs in a multi-cloud environment by dynamically adapting to one or more usage patterns and one or more cost structures. By continuously monitoring resource usage and cost data, the RL agent 316 can predict cost-effective allocations of workloads across different cloud services, and the RL agent 316 can learn to adjust licensing and subscription plans in real-time, balancing performance requirements with cost minimization. Such dynamic enhancements can facilitate utilizing the most efficient and cost-effective cloud services, while avoiding over-provisioning and under-utilization.

Referring again to FIG. 3, one or more embodiments can include collecting real time data on software usage associated with web application 310 (operating on web server 309) and user device 302, user entitlements, historical compliance incidents, compliance actions, and user behavioral patterns. Such an embodiment also includes configuring and/or training deep learning model 330 to learn one or more policies (e.g., optimal policies) for managing compliance and usage control with respect to the software and the user device 302. The deep learning model can then interact with automated action generator 318 and software audit engine 314 (e.g., in connection with processing the software usage data and one or more compliance policies) to determine one or more actions to carry out under various conditions. Additionally, action interpreter 332 determines the best actions from the RL agent 316 environment under current conditions (which can be influenced, for example, by resource usage data and one or more compliance policies).

Additionally, in such an embodiment, the RL agent 316 can receive rewards and/or penalties based at least in part on its actions, such as maintaining compliance, preventing overuse, increasing revenue, etc. Further, one or more embodiments include continuously adjusting one or more compliance and/or affinity thresholds and/or actions based at least in part on the state of usage and compliance, and provide such data to software access policy threshold data structures 306. Also, the RL agent 316 can be enabled and/or trained to dynamically switch between restrictive actions and revenue generating actions depending on compliance levels and one or more designated thresholds, as well as to adjust one or more compliance thresholds to prevent overuse and/or enhance resource allocation.

For example, if user device 302 is approaching one or more consumption limits, the RL agent 316 can temporarily enforce one or more stricter controls and/or offer one or more alternative usage plans to the user. If excessive usage is detected, the RL agent 316 can apply one or more restrictive (e.g., CapEx) controls to limit software consumption and switch back to applying one or more revenue generating (e.g., OpEx) controls once normal usage resumes (e.g., so as to maximize revenue). Such restrictive controls can include, for example, restricting feature use on the software until consumption returns to normal levels. By reducing and/or preventing subscription overuse and dynamically adjusting one or more policies, the RL agent 316 can enhance the security of the software product and protect against potential revenue leakage, balancing needs for restrictive measures with revenue generating opportunities.

At least one example embodiment can include generating and/or implementing a graph which groups data having an affinity towards more restrictive protection-focused actions, and groups data having affinity is towards more revenue generating actions. Such affinity groupings can be used to select an action towards being more protection focused (e.g., a capex action) or more revenue-focused (e.g., an OpEx action). The severity of the selected action can be determined based at least in part on the level of consumption or over-consumption. Such an action formula can be defined in Equation (1) as follows:

$$F ( A ) = ( 1 - ( PU / ENT ) ) \times AFF \times 180 ° \qquad ( 1 )$$

wherein F (A) is the action function, PU is the product use value, ENT is the entitled feature value, AFF is an affinity of 1 or −1, and 180° represents the left quadrant of the graph value (+180 degrees) or the right quadrant of the graph value (−180 degrees).

Additionally, one or more embodiments can include mapping different degree values out to different thresholds percentages on a single plane with relevant actions with increasing severity for each action.

As detailed herein, and in accordance with one or more embodiments, implementing an RL agent to optimize licensing costs and manage compliance in a multi-cloud environment can involve a multi-step approach. First, the RL agent is designed to collect real-time data on software usage, user entitlements, historical compliance incidents, compliance actions, and user behavioral patterns. Such data collection, for example, from a hybrid cloud environment, forms the foundation for training the RL model encompassed by the RL agent. More particularly, in at least one embodiment, the RL model is trained to learn one or more optimal policies for managing compliance and usage control, utilizing a PPO algorithm.

Once the model is trained, the RL agent interacts with the environment, evaluating current usage data and compliance policies to determine the best action(s) to take in response thereto. The RL agent can then receive rewards for maintaining compliance, preventing overuse, and/or optimizing revenue, while penalties can be applied for policy breaches and/or inefficient resource allocation. Further, the RL agent can dynamically adjust one or more compliance thresholds and/or actions in real-time based at least in part on the current state of usage and compliance. For example, the RL agent can switch between restrictive actions and revenue generating actions depending on compliance levels and one or more designated thresholds, facilitating a dynamic and adaptive response to changing usage patterns. Such dynamic adjustments can assist in reducing and/or preventing overuse and enhancing resource allocation, ensuring the software product remains within designated limits. By continuously monitoring and refining the RL model, the RL agent can provide a robust solution for optimizing the software licensing costs and compliance in a multi-cloud environment.

As noted above and further detailed herein, one or more embodiments include leveraging at least one PPO algorithm to process policy-related data in connection with large and/or complex environments such as, e.g., a multi-cloud environment. Such an embodiment can also include utilizing at least one PPO algorithm in connection with processing continuous action data, wherein the actions are not discrete but are dynamic such as, e.g., subscription compliance threshold-related actions.

In one or more embodiments, PPO is a reinforcement learning algorithm that enhances and/or optimizes decision-making processes by directly improving the policy function through gradient ascent on a surrogate objective function. In the example context of optimizing licensing costs for subscriptions in a multi-cloud environment, a PPO algorithm can be particularly effective due to the algorithm's ability to handle large and complex state-action spaces. In such an example context, the PPO algorithm can be implemented to continuously learn and adapt one or more policies by interacting with real-time software usage data, user entitlement data, historical compliance incident data, and user behavioral pattern data. By receiving rewards for maintaining compliance, preventing overuse, and/or optimizing revenue, and by receiving penalties for policy breaches and/or inefficiencies, the PPO algorithm can dynamically adjust one or more compliance thresholds and switch between cost restrictive actions and revenue generating actions. This can assist in enhancing and/or optimizing resource allocation, as well as maintaining software usage within designated limits.

In at least one embodiment, a PPO algorithm can be shown in Equation (2) as follows:

$${L}^{CLIP} ( θ ) = {\hat{E}}_{t} [ min ( {r}_{t} ( θ ) {\hat{A}}_{t} , clip ( {r}_{t} ( θ ) , 1 - ϵ , 1 + ϵ ) {\hat{A}}_{t} ) ] \qquad ( 2 )$$

wherein 0 represents the policy parameter, L^{CLIP} (θ) represents the objective function for the PPO algorithm that is being maximized, Ëₜ represents the empirical expectation over timesteps, rₜ represents the ratio of the probability under the new and old policies, respectively, Âₜ represents the estimated advantage at time t, and & represents a hyperparameter (e.g., 0.1 or 0.2).

The approach of reinforcement learning includes training a model gradually by making the model predict and learn from mistakes (via a penalty function) and/or correct actions (via a reward function). While RL models include gradual learning, a PPO algorithm facilitates that the leaning is stable and efficient by avoiding excessive large policy updates. In Equation (2) noted above, L^{CLIP} (θ) is the objective function for the PPO algorithm that is being maximized, and a purpose of this function is to limit how much the policy can change during each update, which helps in achieving more stable training.

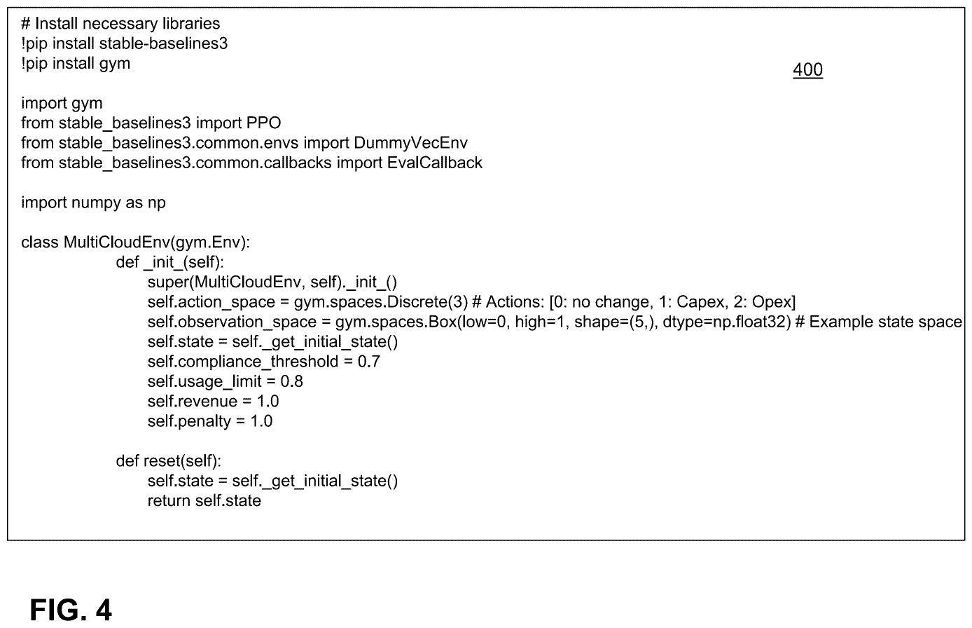

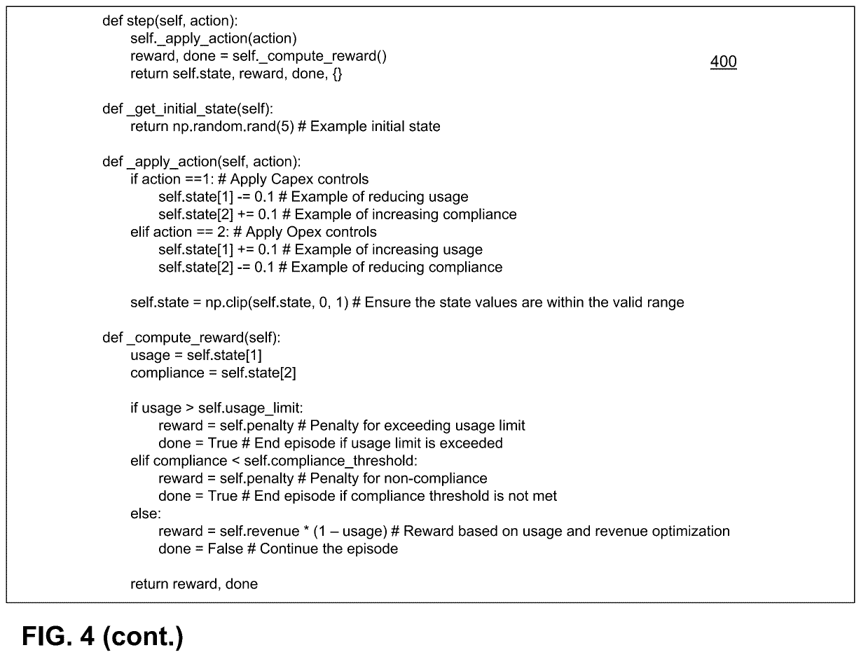

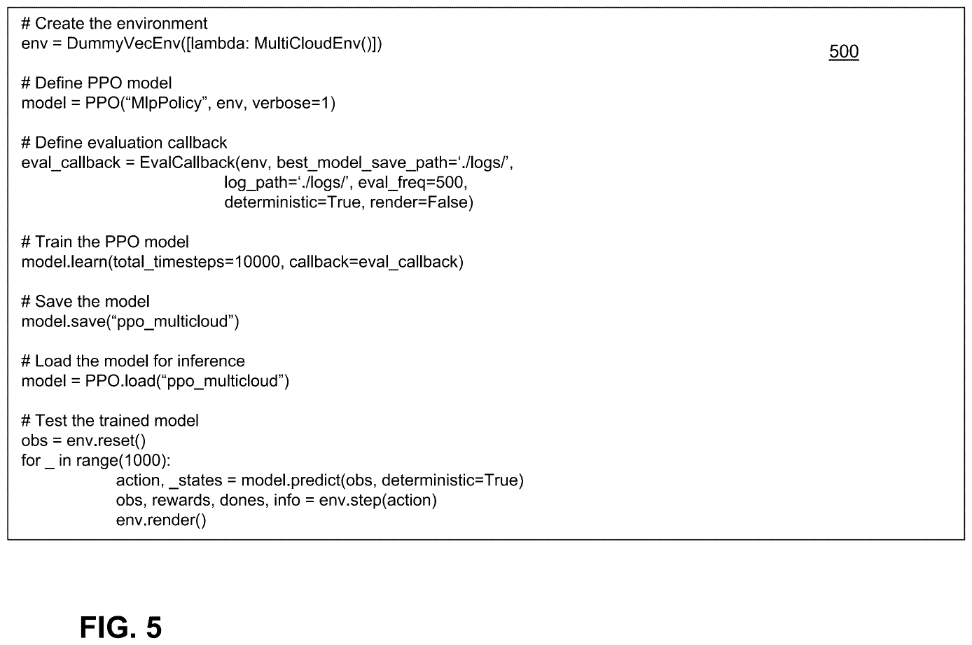

By way merely of example and illustration, pseudocode for configuring and/or implementing an RL agent with a PPO algorithm is shown in FIG. 4 and FIG. 5.

More particularly FIG. 4 shows example pseudocode for installing libraries and defining parameters in connection with implementing at least a portion of an RL agent in an illustrative embodiment. In this embodiment, example pseudocode 400 is executed by or under the control of at least one processing system and/or device. For example, the example pseudocode 400 may be viewed as comprising a portion of a software implementation of at least part of automated software access-related action system 105 of the FIG. 1 embodiment.

The example pseudocode 400 illustrates installing one or more necessary libraries and defining multiple parameters in connection with a multi-cloud environment classification. Such parameters can include, for example, one or more compliance thresholds, one or more usage limits, one or more penalty values, one or more reward values, one or more action-related conditions, etc.

It is to be appreciated that this particular example pseudocode shows just one example implementation of libraries and parameters of an RL agent, and alternative implementations can be used in other embodiments.

FIG. 5 shows example pseudocode for implementing at least a portion of an RL agent with a PPO model in an illustrative embodiment. In this embodiment, example pseudocode 500 is executed by or under the control of at least one processing system and/or device. For example, the example pseudocode 500 may be viewed as comprising a portion of a software implementation of at least part of automated software access-related action system 105 of the FIG. 1 embodiment.

The example pseudocode 500 illustrates steps for configuring an RL agent using a PPO model to enhance a multi-cloud subscription by leveraging a stable-baseline3 library and a Gym library. More particularly, in example pseudocode 500, an environment is defined as a multi-cloud environment. Specifically, a simulated multi-cloud environment is created using a Gym library as well as_apply_action ( ) and_compute_reward ( ) functions, as illustrated in example pseudocode 400 in FIG. 4 and as further detailed below.

In such an example embodiment, an_apply_action ( ) function can include the following configurations: Action 0 (no change) corresponds with no change to the given state; Action 1 (apply capex controls for subscription/licensing) corresponds with reducing usage and increasing compliance; Action 2 (apply OpEx controls for subscription/licensing) corresponds with reducing usage and increasing compliance. Also, in one or more embodiments, the state values can be clipped (e.g., using Numpy) to ensure that the values remain within a valid designated range (e.g., [0, 1]).

Additionally, a_compute_reward ( ) function calculates a reward based at least in part on current usage and compliance levels. If usage exceeds a designated limit, or compliance is below a designated threshold, a penalty is applied and the current episode ends. Otherwise, a reward is calculated based at least in part on the usage, and the current episode continues.

As also illustrated in example pseudocode 500, a PPO model is created using a stable-baseline3 library, which uses a multiple layer perceptron (MLP) policy, wherein MLPs encompass deep neural networks that have multiple layers. Additionally, the PPO model is trained in the multi-cloud environment for a configurable number of timesteps (e.g., 10,000 timesteps). The EvalCallback function is then implemented to evaluate and save the best instance of the PPO model during training. Further, as illustrated in example pseudocode 500, after training, the PPO model is loaded for inference, and a testing loop is carried out which indicates how the model is used for making decisions in the environment.

It is to be appreciated that this particular example pseudocode shows just one example implementation of at least a portion of an RL agent with a PPO model, and alternative implementations can be used in other embodiments.

FIG. 6 is a flow diagram of a process for implementing an artificial intelligence-based access-related system in a multi-cloud environment in an illustrative embodiment. It is to be understood that this particular process is only an example, and additional or alternative processes can be carried out in other embodiments.

In this embodiment, the process includes steps 600 through 606. These steps are assumed to be performed by the automated software access-related action system 105 utilizing elements 112, 114, 116 and 118.

Step 600 includes processing, into one or more data structures, usage data of software by at least one user device, wherein the processing is carried out within a multi-cloud environment. In at least one embodiment, processing usage data of software by at least one user device includes processing, into the one or more data structures, one or more of entitlement data associated with the at least one user device, historical compliance data associated with the at least one user devices, and software usage patterns associated with the at least one user device.

Step 602 includes generating one or more software usage compliance determinations by processing at least a portion of the one or more data structures against one or more software access-related parameters associated with the at least one user device and the multi-cloud environment. In one or more embodiments, generating one or more software usage compliance determinations includes determining a degree of compliance with at least one of the one or more software access-related parameters with respect to the usage data.

Step 604 includes determining one or more software access-related actions to be carried out in connection with the at least one user device by processing at least a portion of the one or more software usage compliance determinations using one or more artificial intelligence techniques. In at least one embodiment, determining one or more software access-related actions to be carried out includes processing at least a portion of the one or more software usage compliance determinations using one or more reinforcement learning techniques. In such an embodiment, processing at least a portion of the one or more software usage compliance determinations using one or more reinforcement learning techniques can include processing the at least a portion of the one or more software usage compliance determinations using at least one proximal policy optimization algorithm in connection with a gradient ascent on a surrogate objective function.

Additionally or alternatively, determining one or more software access-related actions can include determining severity of the one or more software access-related actions to be carried out based at least in part on a level of compliance corresponding to the one or more software usage compliance determinations. Further, in at least one embodiment, determining one or more software access-related actions to be carried out includes determining at least one of one or more restrictive actions and one or more resource generating actions to be carried out in connection with the at least one user device.

Step 606 includes automatically performing, within the multi-cloud environment, at least one of the one or more software access-related actions with respect to the software. In one or more embodiments, automatically performing at least one of the one or more software access-related actions includes automatically restricting access of the at least one user device to at least a portion of the software.

Additionally, in at least one embodiment, the techniques depicted in FIG. 6 can include training at least a portion of the one or more artificial intelligence techniques using one or more of positive feedback and negative feedback to automatically performing the at least one of the one or more software access-related actions. Further, the techniques depicted in FIG. 6 can also include automatically modifying at least one of the one or more software access-related parameters associated with the at least one user device and the multi-cloud environment based at least in part on feedback to automatically performing the at least one of the one or more software access-related actions.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically determine and execute one or more software access-related actions by processing software usage compliance data using artificial intelligence techniques. These and other embodiments can effectively overcome problems associated with security risks and the need for resource-intensive reactive remediation efforts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

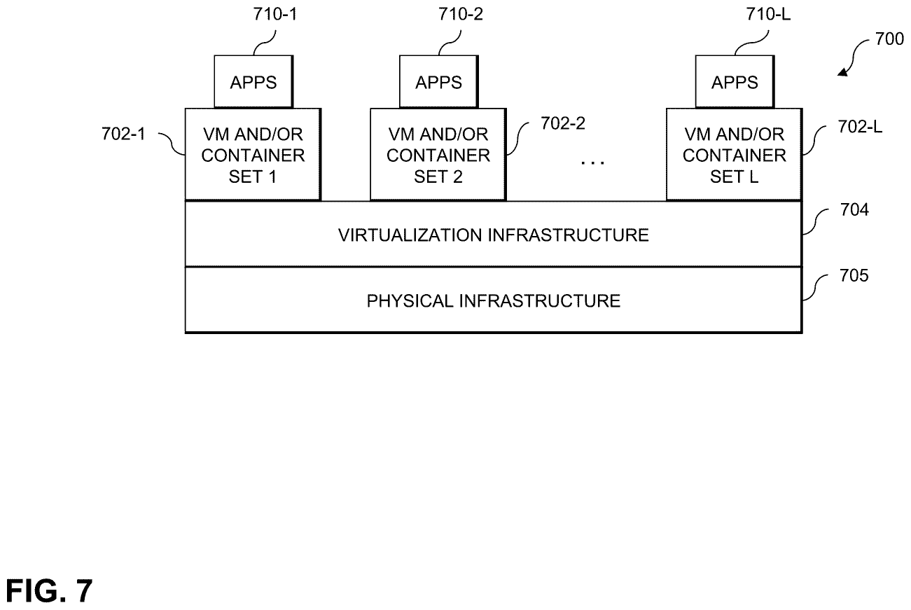

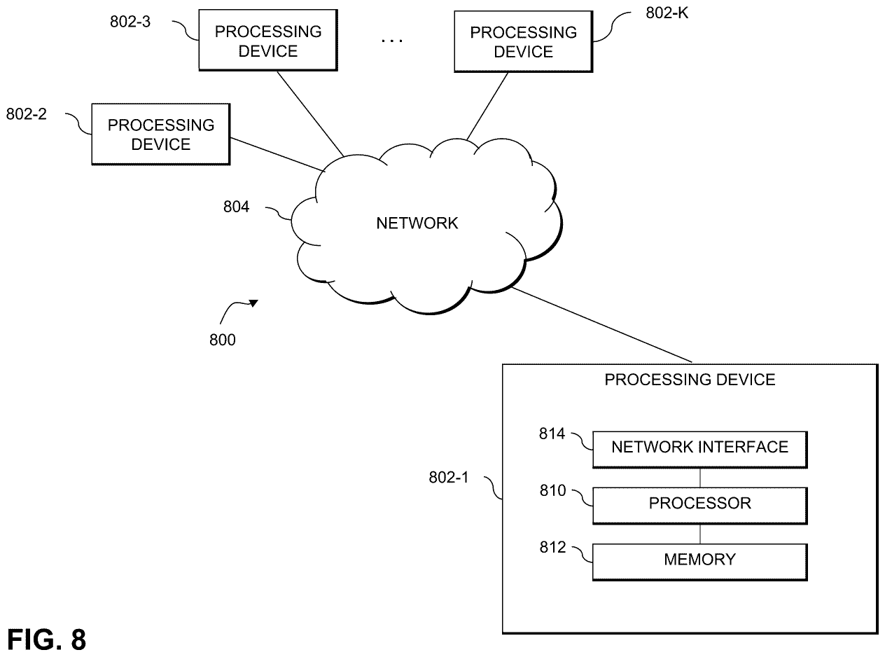

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more information processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing, into one or more data structures, usage data of software by at least one user device, wherein the processing is carried out within a multi-cloud environment;
generating one or more software usage compliance determinations by processing at least a portion of the one or more data structures against one or more software access-related parameters associated with the at least one user device and the multi-cloud environment;
determining one or more software access-related actions to be carried out in connection with the at least one user device by processing at least a portion of the one or more software usage compliance determinations using one or more artificial intelligence techniques; and
automatically performing, within the multi-cloud environment, at least one of the one or more software access-related actions with respect to the software;
wherein the method is performed by at least one processing device comprising a processor coupled to a memory.

2. The computer-implemented method of claim 1, wherein determining one or more software access-related actions to be carried out comprises processing at least a portion of the one or more software usage compliance determinations using one or more reinforcement learning techniques.

3. The computer-implemented method of claim 2, wherein processing at least a portion of the one or more software usage compliance determinations using one or more reinforcement learning techniques comprises processing the at least a portion of the one or more software usage compliance determinations using at least one proximal policy optimization algorithm in connection with a gradient ascent on a surrogate objective function.

4. The computer-implemented method of claim 1, wherein automatically performing at least one of the one or more software access-related actions comprises automatically restricting access of the at least one user device to at least a portion of the software.

5. The computer-implemented method of claim 1, wherein determining one or more software access-related actions comprises determining severity of the one or more software access-related actions to be carried out based at least in part on a level of compliance corresponding to the one or more software usage compliance determinations.

6. The computer-implemented method of claim 1, wherein generating one or more software usage compliance determinations comprises determining a degree of compliance with at least one of the one or more software access-related parameters with respect to the usage data.

7. The computer-implemented method of claim 1, wherein determining one or more software access-related actions to be carried out comprises determining at least one of one or more restrictive actions and one or more resource generating actions to be carried out in connection with the at least one user device.

8. The computer-implemented method of claim 1, further comprising:
training at least a portion of the one or more artificial intelligence techniques using one or more of positive feedback and negative feedback to automatically performing the at least one of the one or more software access-related actions.

9. The computer-implemented method of claim 1, further comprising:
automatically modifying at least one of the one or more software access-related parameters associated with the at least one user device and the multi-cloud environment based at least in part on feedback to automatically performing the at least one of the one or more software access-related actions.

10. The computer-implemented method of claim 1, wherein processing usage data of software by at least one user device comprises processing, into the one or more data structures, one or more of entitlement data associated with the at least one user device, historical compliance data associated with the at least one user devices, and software usage patterns associated with the at least one user device.

11. A non-transitory processor-readable storage medium having stored therein program code of one or more software programs, wherein the program code when executed by at least one processing device causes the at least one processing device:
to process, into one or more data structures, usage data of software by at least one user device, wherein the processing is carried out within a multi-cloud environment;
to generate one or more software usage compliance determinations by processing at least a portion of the one or more data structures against one or more software access-related parameters associated with the at least one user device and the multi-cloud environment;
to determine one or more software access-related actions to be carried out in connection with the at least one user device by processing at least a portion of the one or more software usage compliance determinations using one or more artificial intelligence techniques; and
to automatically perform, within the multi-cloud environment, at least one of the one or more software access-related actions with respect to the software.

12. The non-transitory processor-readable storage medium of claim 11, wherein determining one or more software access-related actions to be carried out comprises processing at least a portion of the one or more software usage compliance determinations using one or more reinforcement learning techniques.

13. The non-transitory processor-readable storage medium of claim 12, wherein processing at least a portion of the one or more software usage compliance determinations using one or more reinforcement learning techniques comprises processing the at least a portion of the one or more software usage compliance determinations using at least one proximal policy optimization algorithm in connection with a gradient ascent on a surrogate objective function.

14. The non-transitory processor-readable storage medium of claim 11, wherein automatically performing at least one of the one or more software access-related actions comprises automatically restricting access of the at least one user device to at least a portion of the software.

15. The non-transitory processor-readable storage medium of claim 11, wherein determining one or more software access-related actions comprises determining severity of the one or more software access-related actions to be carried out based at least in part on a level of compliance corresponding to the one or more software usage compliance determinations.

16. An apparatus comprising:
at least one processing device comprising a processor coupled to a memory;
the at least one processing device being configured:
to process, into one or more data structures, usage data of software by at least one user device, wherein the processing is carried out within a multi-cloud environment;
to generate one or more software usage compliance determinations by processing at least a portion of the one or more data structures against one or more software access-related parameters associated with the at least one user device and the multi-cloud environment;
to determine one or more software access-related actions to be carried out in connection with the at least one user device by processing at least a portion of the one or more software usage compliance determinations using one or more artificial intelligence techniques; and
to automatically perform, within the multi-cloud environment, at least one of the one or more software access-related actions with respect to the software.

17. The apparatus of claim 16, wherein determining one or more software access-related actions to be carried out comprises processing at least a portion of the one or more software usage compliance determinations using one or more reinforcement learning techniques.

18. The apparatus of claim 17, wherein processing at least a portion of the one or more software usage compliance determinations using one or more reinforcement learning techniques comprises processing the at least a portion of the one or more software usage compliance determinations using at least one proximal policy optimization algorithm in connection with a gradient ascent on a surrogate objective function.

19. The apparatus of claim 16, wherein automatically performing at least one of the one or more software access-related actions comprises automatically restricting access of the at least one user device to at least a portion of the software.

20. The apparatus of claim 16, wherein determining one or more software access-related actions comprises determining severity of the one or more software access-related actions to be carried out based at least in part on a level of compliance corresponding to the one or more software usage compliance determinations.
